(19) United States
(12) Patent Application Publication
(10) Pub. No.: US 2005/0244310 A1
(43) Pub. Date: Nov. 3, 2005

(54) Gas treatment apparatus

(75) Inventors: Junichi Tamura, Tokyo (JP); Toshiji Nishiguchi, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/024,931

(22) Filed: Dec. 30, 2004

(30) Foreign Application Priority Data
Jan. 7, 2004 (JP) 2004-002057

(51) Int. Cl. B01J 19/12

(52) U.S. Cl. 422/186.21

(57) ABSTRACT

A gas treatment apparatus for treating gas with non-thermal plasma includes dielectric elements disposed in a space between electrodes. The dielectric elements each include a ferroelectric core covered with adsorbent that supports a metal catalyst or that is mixed with a metal catalyst.

### BACKGROUND OF THE INVENTION

1. Field of the Invention

The present invention relates to a gas treatment apparatus for treating gas with non-thermal plasma.

2. Description of the Related Art

Recently, adverse effects of air pollution caused by volatile compounds and the like on human bodies have become a big concern. Among many techniques proposed for treating such gaseous compounds, treatment of gas that contains volatile organic compounds (VOCs) and the like with plasma, in particular, non-thermal plasma, attracts attention. Research has been conducted to propose methods and apparatuses based on these techniques. Among them, as disclosed in Japanese Patent Laid-Open No. 6-91138 or Japanese Patent Laid-Open No. 2000-325735, is a reactor having a discharge space filled with adsorbent that supports a metal catalyst, or ferroelectric substances that are covered with adsorbent, so as to generate plasma that can treat gas containing small amounts of target substances at a constant decomposition rate. Moreover, the reactor can be advantageously small-sized and produced at lower cost.

However, when the reactor is filled with the adsorbent that supports the metal catalyst, the field intensity for producing a dielectric breakdown is high, and thus a large power supply is necessary for applying a high voltage. On the other hand, when the reactor is filled with the ferroelectric substances covered with the adsorbent, the gas can be treated only by an electrical discharge, and the treatment performance is less sufficient.

### SUMMARY OF THE INVENTION

It is an object of the present invention to provide a gas treatment apparatus for treating gas that contains target substances by producing a dielectric breakdown in a low field intensity to improve the treatment performance.

The present invention provides a gas treatment apparatus for treating gas that contains target substances with non-thermal plasma, including dielectric elements having air gaps therebetween and disposed in a space between a wire electrode for applying a high voltage and a ground electrode, non-thermal plasma being generated in the space. The dielectric elements each include a ferroelectric core covered with adsorbent which supports a metal catalyst.

Furthermore, the present invention provides a gas treatment apparatus for treating gas that contains target substances with non-thermal plasma, including dielectric elements having air gaps therebetween and disposed in a space between a wire electrode for applying a high voltage and a ground electrode, non-thermal plasma being generated in the space. The dielectric elements each include a ferroelectric core covered with adsorbent that is mixed with a metal catalyst.

According to one aspect of the present invention, the dielectric elements covered with the adsorbent that supports the metal catalyst, or adsorbent that is mixed with the metal catalyst are disposed in the apparatus so as to have air gaps therebetween. Therefore, a dielectric breakdown can occur in a relatively low field intensity, and the treatment rate can be improved. As a result, the decomposition rate is not sharply reduced during a long discharge duration, and the target substances contained in the gas can be efficiently decomposed.

Further objects, features and advantages of the present invention will become apparent from the following description of the preferred embodiments with reference to the attached drawings.

### BRIEF DESCRIPTION OF THE DRAWINGS

FIG. 1 is a schematic view of a gas treatment apparatus according to a first embodiment of the present invention.

FIG. 2 is a schematic cross-sectional view illustrating a dielectric particle disposed in the gas treatment apparatus according to the first embodiment of the present invention.

FIG. 3 is a schematic cross-sectional view illustrating a dielectric particle disposed in a gas treatment apparatus according to a second embodiment of the present invention.

FIG. 4 is a schematic cross-sectional view illustrating a dielectric particle disposed in a gas treatment apparatus according to Comparative Example 1.

FIG. 5 is a schematic cross-sectional view illustrating a dielectric particle disposed in a gas treatment apparatus according to Comparative Example 2.

FIG. 6 is a graph illustrating changes in the decomposition rate over time according to Example 1, Example 2, Comparative Example 1, and Comparative Example 2.

### DESCRIPTION OF THE PREFERRED EMBODIMENTS

Embodiments of the present invention will now be described with reference to the drawings, however, the present invention is not limited to these embodiments.

### First Embodiment

In a gas treatment apparatus for treating gas that contains target substances with non-thermal plasma according to a first embodiment, dielectric particles are produced by covering ferroelectric cores with adsorbent that supports a metal catalyst. The dielectric particles are disposed in a space between two electrodes so as to have air gaps therebetween. As a result, electrical discharge can be efficiently performed at a low field intensity. Moreover, the adsorbent can retain the target substances in the space where the electrical discharge takes place for a longer time. In addition, the metal catalyst and the plasma can improve the treatment performance.

The target substances include VOCs, nitrogen oxides, and foul-smelling substances. However, the target substances are not limited to these substances, and the present invention is intended for any gaseous substance.

A gas treatment apparatus for treating gas that contains target substances with non-thermal plasma according to this embodiment will now be described with reference to the drawings.

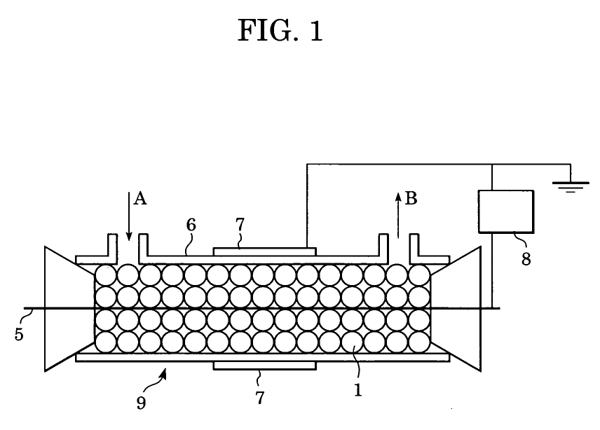

FIG. 1 illustrates the gas treatment apparatus according to this embodiment. A gas treatment apparatus 9 according to the present invention includes a cylindrical ground electrode 7, a barrier 6 disposed in the ground electrode 7, and a wire electrode 5 for applying a high voltage disposed coaxially with the ground electrode 7. A space between the wire electrode 5 and the ground electrode 7 having the barrier 6 disposed therein is filled with dielectric particles 1. Moreover, the gas treatment apparatus 9 includes a power source 8 for supplying a voltage between the wire electrode 5 and the ground electrode 7.

In this embodiment, the space between both electrodes is filled with the dielectric particles so that the dielectric particles have air gaps therebetween.

Gas that contains target substances is treated in the gas treatment apparatus shown in FIG. 1 by the following steps: The power source 8 applies a voltage to the wire electrode 5 to generate non-thermal plasma between the wire electrode 5 and the ground electrode 7 through the dielectric particles 1. Untreated gas A is introduced into the gas treatment apparatus 9, and treated gas B is vented from the apparatus.

The barrier disposed in the ground electrode is dispensable. For example, the cylindrical ground electrode 7 may be a container that accommodates the dielectric particles 1 and the wire electrode 5.

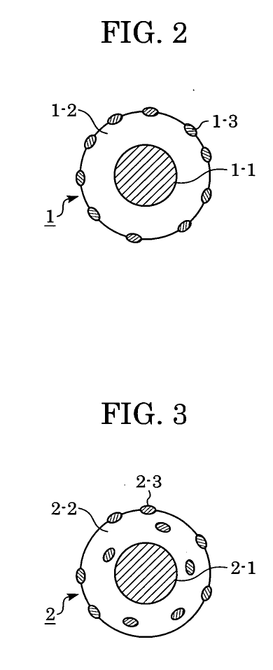

FIG. 2 shows one of the dielectric particles 1 that is disposed in the space between the electrodes shown in FIG. 1. The dielectric particle 1 shown in FIG. 2 is composed of a ferroelectric core 1-1, adsorbent 1-2 covering the ferroelectric core 1-1, and metal catalytic sites 1-3 on the surface of the absorbent 1-2.

### Second Embodiment

A gas treatment apparatus according to a second embodiment has the same structure as that in the first embodiment except that dielectric particles are produced by covering ferroelectric cores with a mixture of adsorbent and a metal catalyst.

FIG. 3 shows one of the dielectric particles 2 that are disposed in the space between the electrodes. The dielectric particle 2 shown in FIG. 3 is composed of a ferroelectric core 2-1, and adsorbent 2-2 covering the ferroelectric core 2-1, the adsorbent 2-2 having metal catalytic sites 2-3 at the interior and the surface of the adsorbent 2-2.

The dielectric particles according to the first embodiment and the second embodiment are preferably ferroelectric. The relative dielectric constant is preferably between 500 and 10,000 to suppress the discharge threshold voltage.

The adsorbent according to the first embodiment and the second embodiment is preferably at least one of activated carbon, silica, alumina, and zeolite.

The metal catalyst according to the first embodiment and the second embodiment preferably includes at least one of platinum, palladium, rhodium, nickel, silver, copper, manganese, ruthenium, rhenium, and iridium.

The metal catalyst may be supported on the surface of the adsorbent as described in the first embodiment, or may be incorporated in the adsorbent and on the surface of the adsorbent as described in the second embodiment. However, the structure according to the second embodiment is more preferable due to the higher treatment rate. The reason for the higher treatment rate is that the catalyst also acts on substances adsorbed in pores of the adsorbent.

The structure having the metal catalyst supported on the surface of the adsorbent according to the first embodiment can be achieved by covering the ferroelectric cores with the adsorbent and then by fixing the metal catalyst on the adsorbent. The structure having the metal catalyst incorporated in the adsorbent and on the surface of the adsorbent according to the second embodiment can be achieved by covering the ferroelectric cores with the adsorbent mixed with the metal catalyst. Thus, the structure according to the second embodiment is more preferable due to a simplified manufacturing procedure.

### EXAMPLES

Effects of the present invention will now be described with reference to examples and comparative examples, however, the present invention is not limited to the examples.

### Example 1

### Dielectric Particles Having Adsorbent Supporting a Metal Catalyst

Performance of the treatment of the target substances in the gas treatment apparatus shown in FIG. 1 was determined. The wire electrode 5 was a tungsten wire 0.5 mm in diameter, the ground electrode 7 was an SUS steel cylinder 12 mm in diameter and 13 mm in length, and the barrier 6 disposed in the SUS steel cylinder was made of quartz glass 1 mm in thickness. The dielectric particles 1 were each 3 mm in diameter, and were composed of spherical barium titanate (having a relative dielectric constant of 1,600) covered with zeolite that supported palladium. The dielectric particles 1 were disposed in the space between the electrodes.

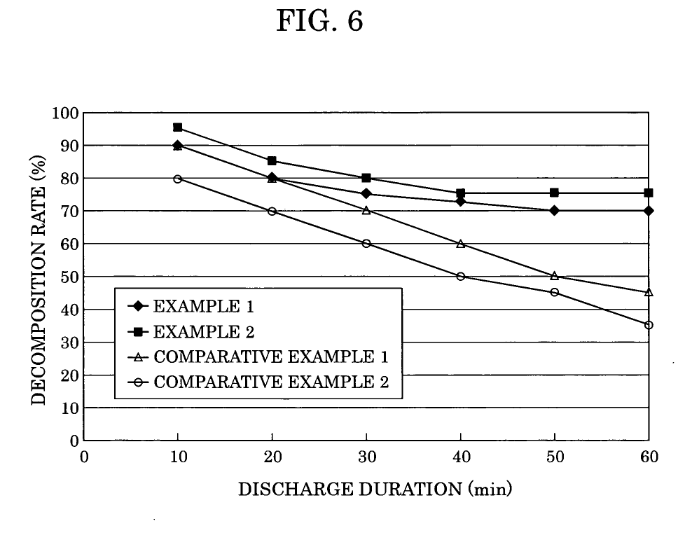

The gas A to be treated was air-based gas (mainly composed of nitrogen and oxygen) containing 10 ppm of ammonia, and was circulated through a reactor, i.e. the gas treatment apparatus 9, at a rate of 10 L/min. Subsequently, a voltage of 7 kV was applied between the wire electrode 5 and the ground electrode 7 through the power source 8 to generate non-thermal plasma for treating the air-based gas. FIG. 6 shows the experimental result determined by measuring the content of the gas B vented from the gas treatment apparatus 9 with a detector tube. In addition to Example 1, FIG. 6 also shows the experimental results in Example 2, Comparative Example 1, and Comparative Example 2. The horizontal axis of the graph is the discharge duration from the start of the electrical discharge, and the vertical axis is the decomposition rate, i.e. the treatment rate, determined with the detector tube. The treatment rate after 60 minutes was 70% in Example 1.

### Example 2

### Dielectric Particles Having Adsorbent Mixed with a Metal Catalyst

Performance of treatment was determined as in Example 1 except that the dielectric particles 2 were each 3 mm in diameter, and were composed of spherical barium titanate (having a relative dielectric constant of 1,600) covered with zeolite that was mixed with palladium.

FIG. 6 shows the experimental result determined by measuring the content of the gas B vented from the gas treatment apparatus 9 with the detector tube. The treatment rate after 60 minutes was 75% in Example 2.

### Comparative Example 1

### Particles Composed Only of a Metal Catalyst and Absorbent Without Dielectric Cores

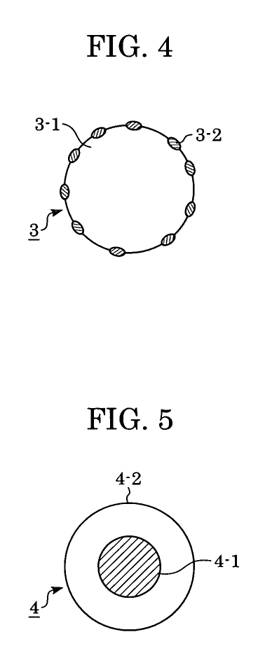

Performance of treatment was determined as in Example 1 except that dielectric particles 3 were each 3 mm in diameter, and were composed of spherical aluminum (having a relative dielectric constant of 10) functioning as the adsorbent 3-1 that supported palladium functioning as the metal catalyst 3-2 as shown in FIG. 4.

FIG. 6 shows the experimental result determined by measuring the content of the gas B vented from the gas treatment apparatus 9 with the detector tube. The treatment rate after 60 minutes was 45% in Comparative Example 1.

### Comparative Example 2

### Particles Composed Only of Dielectric Cores and Absorbent Without a Metal Catalyst

Performance of treatment was determined as in Example 1 except that dielectric particles 4 were each 3 mm in diameter, and were composed of spherical barium titanate (having a relative dielectric constant of 1,600) functioning as the dielectric core 4-1 covered with zeolite functioning as the adsorbent 4-2 as shown in FIG. 5.

FIG. 6 shows the experimental result determined by measuring the content of the gas B vented from the gas treatment apparatus 9 with the detector tube. The treatment rate after 60 minutes was 35% in Comparative Example 2.

As described above, Example 2 showed a high decomposition rate from the early stage to the late stage of the electrical discharge. Moreover, the decomposition rate was not significantly reduced over time.

The decomposition rate in Example 1 was slightly lower than that in Example 2, however, the changes in the decomposition rate over time were substantially the same. Accordingly, Example 1 was also preferable for a long-term electrical discharge due to the small reduction of the decomposition rate.

On the other hand, according to Comparative Example 1, the decomposition rate at the early stage was substantially the same as that in Example 1, however, the decomposition rate was sharply reduced as the discharge duration increased. According to Comparative Example 2, the decomposition rate was low from the early stage of the electrical discharge, and was sharply reduced at a similar rate as that in Comparative Example 1 as the discharge duration increased.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

This application claims priority from Japanese Patent Application No. 2004-002057 filed Jan. 7, 2004, which is hereby incorporated by reference herein.

1. A gas treatment apparatus for treating gas that contains target substances with non-thermal plasma, comprising:
dielectric elements having air gaps therebetween and being disposed in a space between a wire electrode for applying a high voltage and a ground electrode, non-thermal plasma being generated in the space, wherein
the dielectric elements each comprise a ferroelectric core covered with adsorbent which supports a metal catalyst.

2. The gas treatment apparatus according to claim 1, wherein the ferroelectric core has a relative dielectric constant between 500 and 10,000.

3. The gas treatment apparatus according to claim 1, wherein the adsorbent comprises at least one of activated carbon, silica, alumina, and zeolite.

4. The gas treatment apparatus according to claim 1, wherein the metal catalyst comprises at least one of platinum, palladium, rhodium, nickel, silver, copper, manganese, ruthenium, rhenium, and iridium.

5. A gas treatment apparatus for treating gas that contains target substances with non-thermal plasma, comprising:
dielectric elements having air gaps therebetween and being disposed in a space between a wire electrode for applying a high voltage and a ground electrode, non-thermal plasma being generated in the space, wherein
the dielectric elements each comprise a ferroelectric core covered with adsorbent that is mixed with a metal catalyst.

6. The gas treatment apparatus according to claim 5, wherein the ferroelectric core has a relative dielectric constant between 500 and 10,000.

7. The gas treatment apparatus according to claim 5, wherein the adsorbent comprises at least one of activated carbon, silica, alumina, and zeolite.

8. The gas treatment apparatus according to claim 5, wherein the metal catalyst comprises at least one of platinum, palladium, rhodium, nickel, silver, copper, manganese, ruthenium, rhenium, and iridium.
